(19) United States
(12) Patent Application Publication
(10) Pub. No.: US 2025/0060028 A1
(43) Pub. Date: Feb. 20, 2025

(54) ELECTROMAGNETICALLY CONTROLLED HYDRAULIC TRANSMISSION SYSTEM WITH GEARS FOR VEHICLES, WITH OPTIONAL ELECTRICAL GENERATION AND PROPULSION

(71) Applicant: Sebastián Enrique BENDITO VALLORI, Inca (ES)

(72) Inventor: Sebastián Enrique BENDITO VALLORI, Inca (ES)

(21) Appl. No.: 18/724,265

(22) PCT Filed: Apr. 18, 2022
(86) PCT No.: PCT/ES2022/070235

§ 371 Date: Jun. 26, 2024

(51) Int. Cl. F16H 41/02; F16H 61/4061

(52) U.S. Cl. CPC F16H 41/02; F16H 61/4061

(57) ABSTRACT

Engine consisting of a turbine driven by confrontation of explosions and vacuum on both sides of its blades; deflagrations caused by the reaction of oxygen and hydrogen under pressure, or any hydrogenated hydrocarbon and the first mentioned gas, and the shrinkage derived from the precipitation of water vapor obtained from said combinations by means of the aqueous spraying thereof with liquid water.

The present invention refers to the hydraulic and electromagnetic circuits, both equipped with flexible and accommodating conduits, installed in a vehicle which allow the transmission of the thrust exerted by the rotary movement of its motor source to the propeller or propellers that propel it and/or one or more of the wheels that support and drive it; thanks to the developments that are available between both parties: motor and driving support; transmission, whose flow can be reversed in its transit so that the vehicle direction is reversed while maintaining the motor rotation direction or partially suspended this oil traffic in order to avoid superfluous friction.

The system has an electric generator integrated in said circuits: hydraulic and electromagnetic, destined to control the flow in the first and feed the latter, as will be seen; generator, which can also be used as an alternative engine of the vehicle in which it is installed.

The hydraulic system by electromagnetic control presented here has a discretionary reversing system of the direction of flow within it, which allows the driver to reverse in any of the vehicles that are detailed below.
A bicycle, in which the current lateral chain that joins the bottom bracket and the rear wheel disappears, which causes harmful stresses on the front and the rear axle, given the asymmetry of the force applied on both by the chain when produced from the pedals the traction tension of the rear wheel movement; the bottom bracket is here constituted by a central disc between the two pedals and, the wheel, by an equally centralized ring on the bicycle chassis; both pieces are interconnected by the above-mentioned hydraulic circuit and are passed through by the balanced rotary power transmission fluid, as will be detailed.

In addition, by the same method, the driving force can be administered synchronously to the front wheel at will without losing any of its current qualities and functions, which is not feasible today.

On the other hand, as it is equipped with an electric generator integrated in the hydraulic circuit, it can use this energy as an additional contribution to the effort developed by the cyclist or it becomes an electric motorcycle capable of recovering energy during descents from any altitude.

As the hydraulic and electrical circuits are integrated into the chassis of the bicycle, it also gives it a higher aerodynamic coefficient than that of classic bicycles.
Any vehicle: air, sea or land, in which the hydraulic system by electromagnetic control presented here transfers energy by fluid pressure from the engine, whatever its power source, to the propellers or wheels available on the vehicle in question for its propulsion and support; with this, those said vehicles are optimized in weight as the transmission and development of the primary driving energy are lightened, and the number of component parts is saved.

In a land vehicle, it enables the number of driving wheels to be discretionary for the driver.

In naval assembly, the through-hull hole proper to the shaft that runs from the engine to the propeller, sometimes causing unwanted waterways, is avoided.

In naval vessels and aircraft, the propeller can be freely oriented in three dimensions on a support point, since the flexibility of its power acquisition path allows it, so it constitutes a steerable propeller in vertical ascent or horizontal flight. in an aerial vehicle and a balancing of the horizontal thrust in a marine ship as well as the rudder of any vehicle that integrates it.

According to the previous investigation carried out, the device claimed here does not currently exist, so I request that you grant me the rights corresponding to the invention that is described below in a practical case of industrial application, which is reinforced in its understanding with a series of schematic figures that represent it; In all of them, the dashed lines followed by a dot indicate the hollowness of the space on which they are drawn and those that have a discontinuous line that the part thus reflected is hidden in that view.

For explanatory purposes, here it should be added to the above that the indicated hydraulic transmission occurs between a flow emitting element, which we will call the motor, and other receivers of said flow, in a discretionary number as will be explained, which we will call in general for now action item; both elements: motor and action, are analogous in their constitution, assuming both the confronted installation of two container bodies, mirror image of each other in their geometry, which only differ in that one carries a series of electro valves installed while the another does not, leaving a free flow through it as will be seen; the first of such a pair receives said fluid, controlling its circulation, while the second evacuates the same whenever it receives it, which is why we will call them respectively the supply casing and the evacuation casing.

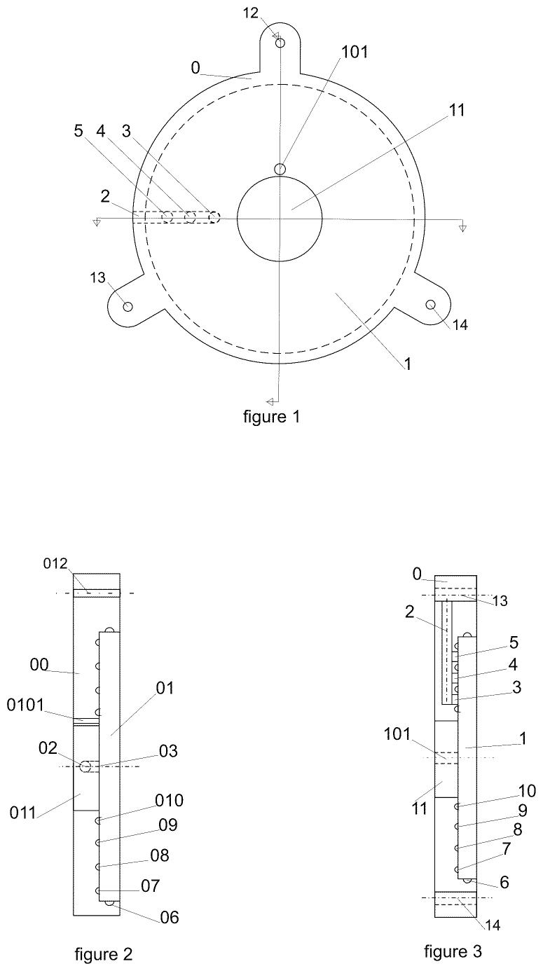

FIG. 1 shows the external elevation view of a feeding case, with the logo 0. The feeding case (0), which (0) is constituted by a rigid, dense and pressure resistant cylindrical container; its geometry is characterized by having:
Three equal protrusions, pierced by respective threaded cylindrical holes, generically called feeding case hook, under the respective designation in this figure of numbers 12, 13 and 14.
A coaxial hole that passes centered through the cylindrical body of the same (0), indicated with the number 11 which we will call from now on the feeding case way.
A cylindrical cavity, on its hidden side in this view, of a certain depth and coaxial to it (11); concavity, designated here with the number 1 which we will call the feeding casing sinus.
Transversely to said feeding case (0), under the sign 2 and hidden in this view due to its internal location in the feeding case (0), a lateral duct opens which we will call the feeding duct; it (2) has its beginning on the external side of feeding case (0) and communicates successively with three solenoid valves, located respectively at different radii of the sinus (1), which we will call and designate in this figure respectively as Low solenoid valve, with symbol 3, medium solenoid valve, with 4 symbol, and high solenoid valve, with 5.
A cylindrical hole, which we call feeding case counter and we see under sign 101, opens over the feeding case way (11), parallel to it, communicating both bases of the feeding case (0).

FIG. 2 shows the profile of an evacuation case; As has been said, the geometry of both cases are mirror each other, except that the feeding case (0) incorporates three solenoid valves (3, 4 and 5), in order to differentiate them graphically for explanatory purposes, in all the figures the annotation of the parts drawn on the evacuation case differ from those shown in the previous figure in that their symbols have a 0 before the parts of those former.
A coaxial hole, with the number 011 indicated which we will call the evacuation case way from now on, crosses cylindrical body of the evacuation case (00) through its center.

Thus, with the emblem 00, this figure represents the view from the right of the cut by the line with arrows to the left drawn in the previous figure, corresponding to its symmetrical twin sister: the feeding case (0).

So we have:

Three equal protuberances, two of which are not seen in this view, pierced by respective threaded cylindrical holes generically called evacuation case coupling and the upper one of them is seen here under the designation of the number 012.

A hollow of a certain depth, cylindrical and coaxial to the evacuation case (00), which we will call the evacuation case sinus, designating it with the number 01.

A coaxial hole, marked with the number 011, that trespasses evacuation case (00) through the center of its cylindrical body; hole, which we will call from now evacuation case way.

Over the evacuation case way (011), a cylindrical hole opens parallel to it connecting the two bases of it (00) which we call the evacuation case counter and we see under sign 0101.

A semi-toroidal channel is open in the wall of the evacuation case sinus (01) and concentric to it (01), which we will call evacuation rolling channel and is indicated on its lower side with the symbol 06.

Under sign 02 you can see the opening of the evacuation duct; the same (02) has its beginning on the external side of the evacuation case (00) and communicates with it (02) an open conduit that we will call low outlet, with initials 03, which is a channel in its opening towards evacuation case sinus (01).

After the low outlet (03) and, therefore, hidden in this view and consequently without designation, the middle outlet and the high outlet open successively from the evacuation duct (02); the three outputs: low (03), medium and high, as will be seen, are confronted respectively in their assembly in the system with the low (3), medium (4) and high (5) solenoid valves located in the supply case (0).

Likewise appears the openings corresponding to a series of semi-toroidal grooves of different radius, made in the wall of the evacuation sinus (01) and concentric to it (01), which we will designate and know as:

With the anagram 07, the high evacuation static joint channel.

With the anagram 08, the medium-high evacuation static joint channel.

With the anagram 09, the medium low evacuation static joint channel.

With the anagram 010, the low evacuation of static joint channel.

FIG. 3 shows the top view of the feeding case cut by the line with arrows pointing downwards reflected in FIG. 1; the current figure repeats the notation of FIG. 1, to which a semi-toroidal channel has been added, open in the wall of the feeding case (0) and concentric to it (0), which we will call feeding rolling channel and is indicated on its lower slope with the symbol 6.

The diameter of both static rolling channels: feeding (6) and evacuation (06) is the same.

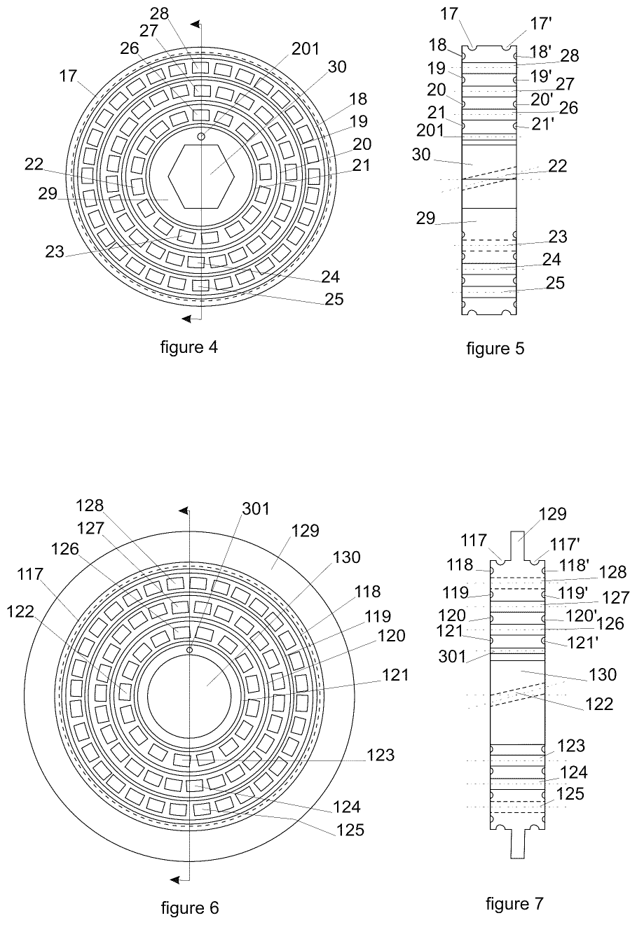

FIG. 4 shows the elevation view of the outside of a cylindrical piece, which we will call the motor rotor, detailed with the number 29.

We can see, under number 17, centered on its side (29), which makes it hidden, a semi-toroidal opening that we will call motor rolling channel one.

The motor rotor (29) is pierced, in its center and coaxially to it, by a hexagonal opening that we will call the power take-off, here designated with the number 30.

At motor rotor (29) base we see here a series of semi-toroidal concavities open up, which we will designate and know as:

With the anagram 18, the upper channel feeding motor joint.

With the anagram 19, the medium-high channel feeding motor joint.

With the anagram 20, the low middle channel feeding motor joint.

With the anagram, 21 the lower channel feeding motor joint.

A central hexagonal hole, open coaxially to the motor rotor (29), which we will call power take-off, is reflected with the number 30.

The motor rotor (29) is traversed obliquely from base to base by three concentric series of holes, whose respective sets of separating blades will be known as the larger drive turbine, the middle drive turbine and the smaller drive turbine. In this graphic representation we can see identified some of its spans by the following numbers: 22, 25 and 28 at the larger motor turbine, 24 and 27 of the medium motor turbine and 23 and 26 of the smaller motor turbine.

Over the power take-off (30), a cylindrical hole is opened that connects the two bases of the drive rotor (29) perpendicularly; we call it motor counter and we see under sign 201.

The vertical line with arrows to the left describes the section shown in the following figure.

FIG. 5 represents the right side view of the aforementioned section of a motor rotor (29) with the same designation as the previous figure, although here a new semi-toroidal opening is seen which we will call motor rolling channel two, designated with the number 17′ in its superior sector; Both motor rolling channel (17 y 17′) are identical to each other and symmetrical with respect to the motor rotor (29), having a diameter equal to that of the bearing spheres that will be described later.

In the two bases of the motor rotor (29) we can see that respective channels of mobile motor joint are opened; those located on the left side are the views in the previous figure, while we will call those located on the right and indicate in their respective upper slopes as:
Upper channel evacuation motor joint, marked with the anagram 18′.
Medium-low channel evacuation motor joint, indicated with the anagram 19′.
Medium-high channel evacuation motor joint, indicated with the anagram 20′.
Lower channel evacuation motor joint, indicated with the anagram 21′.

In the present graphic representation we can see some of its bays identified by the following numbers: 22, 25 and 28 of the larger motor turbine, 24 and 27 of the medium motor turbine and 23 and 26 of the smaller motor turbine.

The opening (22) describes the obliquity of all of them with respect to the bases of the drive rotor (29).

In FIG. 6 we see the elevation of a new rotor, which we will call the wheel rotor and is designated with the anagram 129, which is identical in its physical constitution to the motor rotor (29) except that it has an external ring solidly fixed to it (129) and the power take-off (30) is replaced by a cylindrical opening, which we call vain and we see with the symbol 130; Being basically the same as the motor rotor (29), the parts of the wheel rotor (129) are indicated with the same numbering as in the former (29), but now adding a 1 in front of each respective number and they are known by the same name in the that the word motor is replaced by wheel.

On the opening with the symbol 130, a cylindrical hole is opened that connects the two bases of the wheel rotor (129) perpendicularly, which we call the wheel counter and we see under the sign 301.

FIG. 7 shows us the view from the right of the wheel rotor (129) sectioned by the line with arrows to the left shown in the previous figure, repeating its notation to which it adds, under number 117′, a semi-toroidal slot identical to wheel rolling channel one (117) and symmetrical to it with respect to the wheel rotor (129) which we will call wheel rolling channel two; both wheel rolling channel, one (117) and two (117′), have a diameter equal to that of a bearing sphere that will be described later.

In the two bases of the wheel rotor (129) we can see that two channels of moving motor joint open; those located on the left side are the views in the previous figure, while we will call those located on the right and indicate in their respective upper slopes as:
Upper channel evacuation wheel joint, indicated with the anagram 118′.
Upper middle channel evacuation wheel joint, marked with the anagram 119′.
Lower middle channel evacuation wheel joint, marked with the anagram 120′.
Lower channel evacuation wheel joint, indicated with the anagram 121′.

In this graphic representation we can see some of its openings identified by the following numbers: 125 and 128 of the larger wheel turbine, 124 and 127 of the medium wheel turbine and 123 and 126 of the smaller wheel turbine.

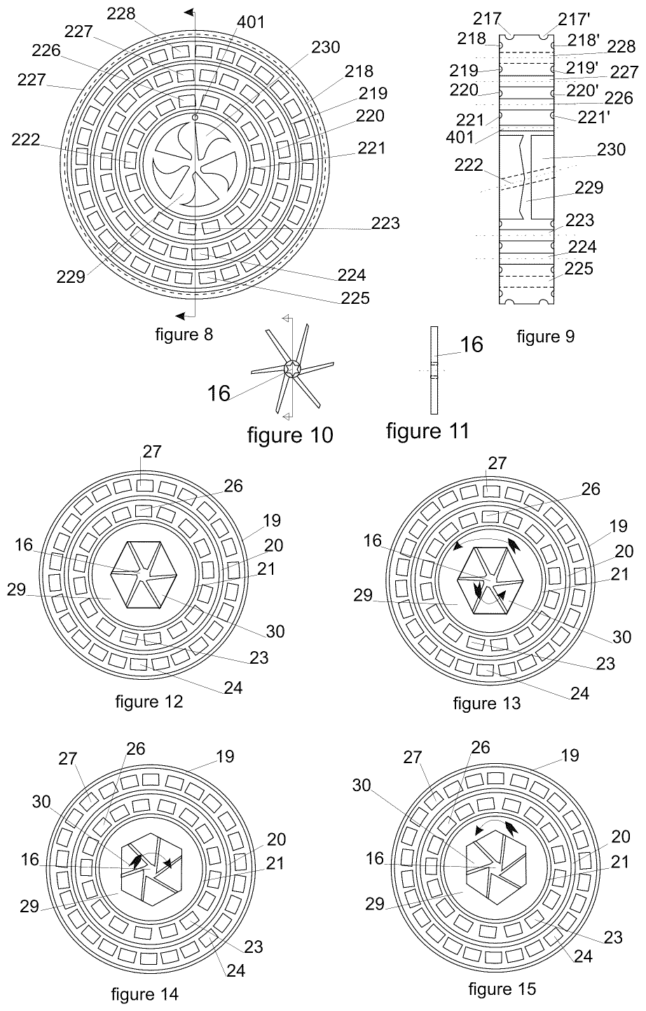

In FIG. 8 we see the elevation of a new rotor that is identical in its physical constitution to the wheel rotor (129), except that it does not have the external ring solidly fixed to it, but rather that in its center it incorporates the fixed blades of a propeller, so we will know it as a propeller rotor, designated with the anagram 229; the symbol 230 designates the openings between said blades, openings, which we call propeller paths.

Being also basically the same as the drive rotor (29), the parts of the propeller rotor (229) are indicated with the same numbering as in the former (29) but adding a 2 in front of each respective number, and are known with the same denomination substituting respectively to its name the word motor by propeller.

Connecting perpendicularly the two bases of the propeller rotor (229), a cylindrical orifice is opened over the helix paths (230), which we call the propeller counter and we see under sign 301.

In FIG. 9 we see the view from the right of the propeller rotor (229) sectioned by the line with arrows to the left shown in the previous figure, repeating its notation to which it adds, under number 217′, a semi-toroidal gap identical to the propeller rolling joint one (217) and symmetrical to it with respect to the propeller rotor (229) which we will call propeller rolling joint two; both propeller rolling joint, one (217) and two (217′), have a diameter equal to that of a bearing sphere that will be described later.

In the two bases of the propeller rotor (229) we can see that two channels of propeller rolling joint open; those located on the left side are the views in the previous figure, while we will call those located on the right and indicate in their respective upper slopes as:
Upper channel propeller evacuation joint, indicated with the anagram 218′.
Medium-low channel propeller evacuation joint, indicated with the anagram 219′.
Medium-high channel propeller evacuation joint, marked with the anagram 220′.
Lower channel propeller evacuation joint, indicated with the anagram 221′.

In the present graphic representation we can see some of its bays identified by the following numbers: 225 and 228 of the larger propeller turbine, 224 and 227 of the medium propeller turbine and 223 and 226 of the smaller propeller turbine.

FIG. 10 is the external elevation drawing of a pinion, which we thus name under the designation 16; the same (16), has a rigid cylindrical center open in its central axis by a six-point star gear; It also has, surrounding the center of the cylinder and forming a single immovable piece with it (16), six teeth made of resistant and flexible material, whose length is adequate for the pinion (16) to fit completely into the power take-off (30), as will be seen in FIGS. 12, 13, 14 and 15.

FIG. 11 represents the profile of the pinion (16) with the same designation as the previous figure.

FIG. 12 shows the view of a section of the motor rotor (29) seen in FIG. 4 in which it has been removed from the outer edge of the medium-high channel feeding motor joint (19); Following the denominations and signs of said figure, in the present, a pinion (16) has been installed inside the power take-off (30).

FIGS. 13, 14 and 15 are a repetition of the previous one, except for the respective arrows drawn on each of them; The reason for this reiteration of images and diversity of arrows will be discussed in explanation.

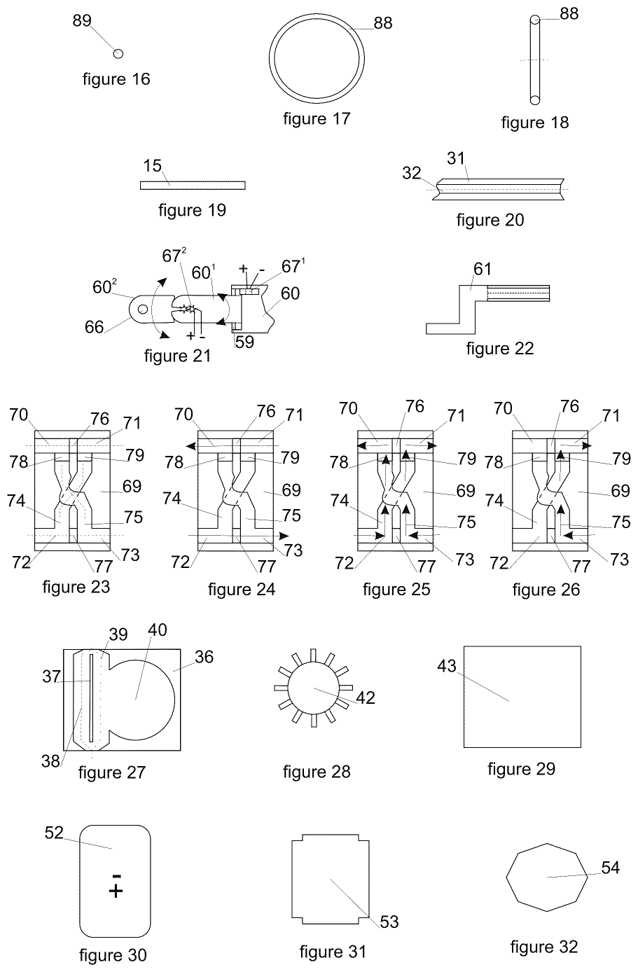

FIG. 16 depicts a rigid sphere which is called a sphere and designated as 89; the sphere (89) has the same diameter than the rolling channels of feeding (6) and evacuation (06), for the motor rotor (17 and 17′), the wheel rotor (117 and 117′) and for the propeller rotor (217 and 217′).

FIG. 17 represents the elevation view of an O-ring, which we will now generically call a joint under the designation, also generic, of number 88; the joint (88), is capable of containing the fluid escape between the two bodies that contain it.

FIG. 18 represents the profile view of said joint under the same designation.

FIG. 19 is the drawing of the profile of a cylindrical threaded connection element, which we will generically call an anchor and is designated here with the number 15; The anchor (15) will be in charge of the firm and immobile fixation between two cases: one for feeding (0) and the other for evacuation (00), so it will have the same thread profile as the respective case evacuation hooks (012, 013 and 014) and feeding (12, 13 and 14) of those (00 and 0); in addition, it will also link both (0) and (00) firmly and stably with the structure of the vehicle they serve. Given its profuse repetition in this description, in its particular designation the number 15 will be used, to which another number will be attached, in subscript and superscript, depending on the case, as will be seen.

FIG. 20 shows the elevation of a pressure resistant hydraulic fluid communication hose, which can be rigid or flexible at will; it is known as a sleeve and designated with the number 31, its channel being with the sign 32; the conduit (31) is suitable for communicating through any of its two mouths, keeping it sealed with the outside, to the different elements that make up the hydraulic system claimed here.

FIG. 21 is the drawing of the vertical diametral section of a swivel ball joint device formed by:
a. The vehicle, which we will call like this and indicate with the number 60; the same (60), has a cylindrical hole open on its right side, which is firmly closed by a ring, which we will thus know under the designation number 59 on its lower side.

In addition, the vehicle has installed, in the area that we see, an electric motor marked with the number 67¹, which we call the director, which (67¹) is equipped with a transmission gear whose blades are located in the open space between the vehicle (60) and the ring (59); at the end of their terminals you can see the signs of their respective polarities.
b. A cylinder of rigid material, which we call the guider and we indicate with the number 60¹, which has a gear on its right end, the same as the one on the director (67¹).

In addition, the guider (60¹), has an electric motor installed that we call like this; at the end of their terminals you can see the signs of their respective polarities.

At its left end, it rounds its base, ending in a hemisphere.
c. A rigid bond, which we know as a bond under the number 60²; it is made up of two prismatic bars that form a single body, a larger one on the left and a smaller one on the right.

The left end of the larger bar is convex rounded and, near it, there is a cylindrical hole in which it is possible to assemble the anchor (15); on its right side, it also has a rounded profile, although this time concave, with the same radius of concavity as that of the aforementioned hemisphere for the guider (60¹).

From the center of said concavity, a smaller bar emerges, which has a fixed gear at its final end, the same as the one of the elevator (67²) in which it fits.

The arrow that appears on the link (60²) indicates the possibility of its pivoting with respect to the guider (60¹) by the action of the elevator (67²).

The arrow that appears on the guider (60¹) indicates the possibility of its pivoting with respect to the vehicle (60) by the action of the director (67¹).

FIG. 22 is the elevation of a pedal, which we know as such, here under designation 6¹; At its right end, the six-pointed star gear can be seen that fits into the gear of the pinion (16) already mentioned.

FIGS. 23, 24, 25, and 26 represent the elevation of a parallelepiped made of rigid, compact and pressure resistant material known as an inverter with the sign 69. The body of the inverter (69) is crossed from side to side by two parallel ducts, orthogonal to the walls of the former (69)

Both ducts are subdivided by two solenoid valves installed in their respective centers, which will be detailed below, so that each sector of said ducts will be known as:
Upper right channel to the one located above and to the right of the inverter (69) and indicated with the number 70.
Upper left channel which is located above and to the left of the inverter (69) and indicated with the number 71.
Lower right channel which is located below and to the right of the inverter (69) and indicated with the number 72.
Lower left channel which is located below and to the left of the inverter (69) and indicated with the number 73.

The upper right channel (70) and the lower left channel (75) are interconnected by a pipe, which we will call pipe a with designation 74, which (74) passes over another pipe, that we will call pipe b indicated with sign 75, used to connects the lower right channel (72) with the upper left channel (71); both pipes: a (74) and b (75) do not have any connection between them.

The mouths of the upper channel (70) and the lower channel (71), as has already been pointed out, are both connectable to the end of a hydraulic conduit (31) keeping firm sealing in their respective contacts and joining their channel a (70) or its channel b (75) with the channel (32) of the hydraulic conduit (31) attached to it.

The inverter (69) has the following solenoid valves:

Designated with the number 76, the upper valve, installed between the upper right channel (70) and the upper left channel (71).

Designated with the number 77, the lower valve, installed between the lower right channel (72) and the lower left channel (73).

Designated with the number 78, the reversing valve a, installed inside the pipe a (74).

Designated with the number 79, the reversing valve b, installed inside the pipe b (75).

The difference between FIGS. 21, 22 and 23 will be discussed later in the explanation.

FIG. 27 shows the elevation of a body made of rigid, compact and electro-insulating material, which we know as a generator/motor under designation 36, which has open:

Two ducts, parallel to each other that cross it from side to side, which we will call respectively as free passage, detailed with the sign 38, and energetic passage that's with 39.

An electric heater thermostat, which we will call a heater, is seen under the sign 37 which also constitutes the watertight separation between the free passage (38) and the energetic passage (39); With the plus and minus signs you can see the terminals.

The heater (37) has such a length that it gives way at its upper and lower ends so that the free passage (38) and the energetic passage (39) communicate with each other, converging in both places in a single opening.

A blind cylindrical hole, open only at the base seen here, which we call the turning cavity, indicated here under the designation 40.

The energetic passage (39) communicates tangentially with the turning cavity (40).

FIG. 28 reflects an element which we know as an inductor designated with the sign 42, which is made up of a rigid and dense disk, which has a series of radial blades of equal thickness forming a single body with it (42); These blades are dense, rigid and magnetized, maintaining homogeneity in their particular magnetic fields, so that their respective most radial poles coincide in sign.

The total diameter of the inductor (42) is the same as that of the turning cavity (40), so that it can rotate in it while maintaining sealing in its mutual contact areas.

FIG. 29 is the elevation of a lid, a rigid and dense parallelepiped, intended to cover the turning cavity (40), closing it hermetically; we call it a lid and indicate it with the sign 43.

FIG. 30 is the elevation of an electric battery, on which we see its two poles indicated with the respective signs + and −; it will be known as battery and designated with the number 52.

FIG. 31 represents the elevation of a multitasking electronic control device that we call control under the designation 53.

FIG. 32 shows us the elevation of an interactive electromagnetic data management screen that we call manager and designate with the symbol 54.

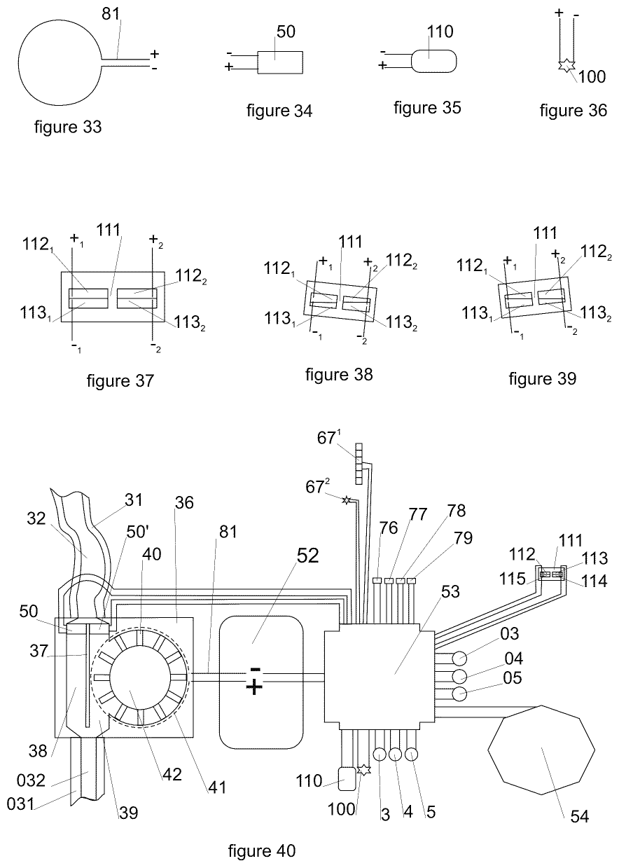

FIG. 33 shows the elevation drawing of an electric coil, which we will call armature with designation 41; at the end of their terminals you can see the signs of their respective polarities.

FIG. 34 shows the elevation of an adjustable pitch solenoid valve, which we will generically call a regulator, here under symbol 50; at the end of their terminals you can see the signs of their respective polarities.

FIG. 35 shows the elevation of the photoelectric cell, which we will call that and we see here with sign 100; at the end of their terminals you can see the signs of their respective polarities.

FIG. 36 shows the elevation of a focus of electric light, which we will call focus and we see here with the number 110; at the end of their terminals you can see the signs of their respective polarities.

FIG. 37 describes the horizontal position elevation of an electronic level, which forms a fixed part of the vehicle constitution which it is installed, consisting of a rigid, compact and electro-insulating parallelepiped, which we will call level with designation 111, which It has two open spaces in its body without any opening to the outside.

The body of the level (111) is crossed by four vertical electrical conductors, each designated at its ends with its own electrical polarity.

The interior of these spaces contains the amount of dielectric liquid needed to fill it up to half.

In the lower part of both containers, the dielectric housed there is marked with the numbers 1131 and 1132, respectively, while the respective upper gaseous chambers are marked with the numbers 1121 and 1122.

FIG. 38 repeats the previous one but, now, the level (111) is tilted to the right with the consequences that will be detailed in the explanation.

FIG. 39 repeats the previous one but, now, the level (111) is inclined to the left with the consequences that will be detailed in the explanation.

FIG. 40 represents the elevation of the entire electrical device, with its electrical inter-connections, typical of the system claimed here; Its parts and components, already particularly detailed in previous figures, follow the same symbology here, they are:

The generator/motor (36), which integrates the armature (41) in a fixed way, in its wall of the turning cavity (40), for which it constitutes its stator; in it (40) the inductor (42) is housed with rotation capacity.

It should be said here that the turning cavity (40) thus arranged is permanently isolated from the outside by the cover (43).

Inside the upper beginning of the free passage (38), a passage regulator (50) is installed, which we now call the free passage regulator to differentiate it from its twin, located at the upper beginning of the energetic passage (39), at which we will call here energetic step regulator under symbol 50′.

A sleeve (31) is seen connected to the upper part of the generator/motor (36), keeping it sealed from the outside, so that its channel (32) leads into the free (38) and energetic (39) passages; here we will call it arrival sleeve.

A second sleeve, now designated as 031, is connected to the lower part of the generator/motor (36), keeping it sealed from the outside, so that its channel, now designated as 032, leads into the free (38) and energetic passages. (39); here we will call it outlet sleeve.

A battery (52), in electrical connection with the generator/motor (36) and with the control (53).

A control (53), in electrical communication with:

An electronic level (111).

A manager (54).

The low (3), medium (4), and high (5) motor rotor case solenoid valves.

The solenoid valves of the case either wheel or propeller, low (03), medium (04) and high (05).

A light bulb (100).

A photoelectric cell (110).

An upper valve (76).

A lower valve (77).

A reversing valve a (78).

A reversing valve b (79).

A free passage regulator (50).

An energetic step regulator (50′).

A heater (37).

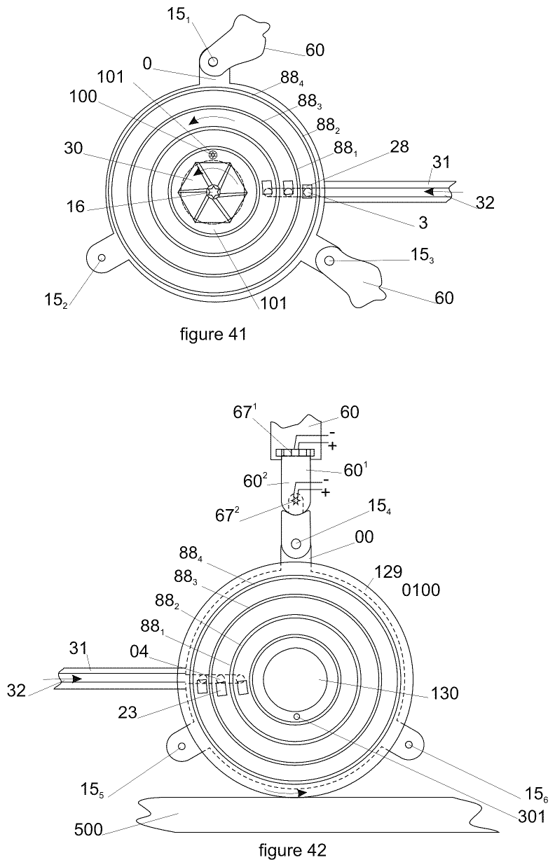

FIG. 41 is the drawing of the elevation of an assembly that includes a feeding case now designated with the number 0, inside which (0) is located a motor rotor (29) that has installed in its power take-off (30) a pinion (16).

Among the solenoid valves of this one (0), the low one (3) is indicated.

It is specified with the already established designation followed by a subscript number:

Also appears in the figure a bay of the main motor turbine (28).

Three anchors are listed as: 15¹ top, 15² bottom left, and 15³ bottom right.

Trio (15¹, 15² and 15³), which constitutes the firm and stable mooring of the feeding casing (0) with two sections of the vehicle, detailed respectively with the numbers 60¹ and 60².

A section of a sleeve (31) part with its channel (32).

A light source (100) can be seen, installed in the power supply counter (101), through the motor counter (201), since the angle of rotation of this (201) makes its opening coincide with that (100).

For the purpose of introducing the motor rotor (29) inside (01) the evacuation casing (00), four toroidal holes appear, created by the confrontation of their respective joint channels; in each of them there is a board, called and designated as follows:
The high evacuation joint, designated on its lower side with the number 88₄, which fills the toroidal joint created by the confrontation of the channel of the high evacuation static joint (07) and the channel of the upper evacuation motor joint (18′).
The medium-high evacuation joint, designated on its lower side with the number 81₃′, which fills the toroidal joint created by the confrontation of the channel of the static medium-high evacuation joint (08) and the channel of the upper motor joint (219′).
The lower middle evacuation joint, designated on its lower side with the number 81₂′, which fills the toroidal joint created by the confrontation of the lower middle evacuation static joint channel (09) and the upper motor joint channel (20′).
The low evacuation joint, designated on its lower side with the number 81₁′, which fills the toroidal joint created by the confrontation of the medium-high evacuation static joint channel (10) and the upper motor joint channel (21).

The assembly is firmly and stably joined by three ties, of which only the upper one (155) can be seen, so that the supply case (0) and the evacuation case (001) pass through it (158). and house (01 and 001) a motor rotor (29) and their respective sinuses (1 and 01).

FIG. 42 is the elevation drawing corresponding to the assembly of an evacuation case (00) within which sinus (01) a wheel rotor (129) is partially located, since its ring protrudes from it (00).

In the figure you can see:

The evacuation case (00).

Its medium output (04).

A sleeve section (31), which is adjacent to the section seen in the previous figure, with its channel (32).

The four joints already alleged in the previous figure, which, being identical in each category, coincide in their numbering with that already established.

A bay of the larger motor turbine (28).

The three anchors: 15₄ the one at the top, 15₅ the one at the bottom left and 15₆ the one at the bottom right.

Trio (15₄, 15₅ and 15₆), which constitutes the firm and stable anchoring of the evacuation case (00) with three sections of the vehicle, detailed respectively with the numbers 60₁′, 60₂′ and 60₃′.

The wheel counter (301) can be seen, through which no light source can be seen, since the angle of rotation of the wheel rotor (129) means that it (301) does not coincide in its opening with the lighting device or sensor installed in the evacuation casing counter (0101).

With the number 500 you can see the ground on which the wheel rotor (129) rests.

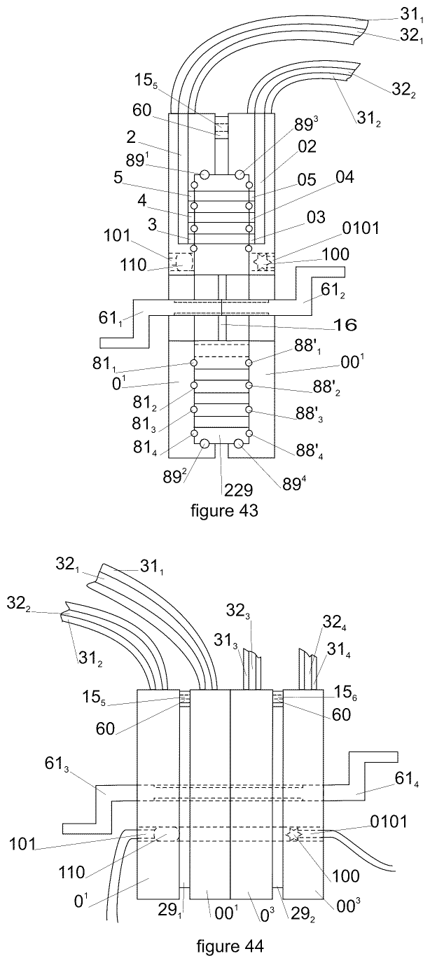

FIG. 43 is the profile representation of the diametral section of a complete motor device formed by:

A feeding case (01) in which you can see:
its supply duct (2).

Its low (3), medium (4) and high (5) solenoid valves.

A sensor (110), located in the feeding case counter (101).

A motor rotor (29).

An evacuation case (00) showing:
it evacuation duct (02).
its low (03), medium (04), and high (05) outputs.

A light bulb (100), located in the evacuation case counter (0101).

Two spheres, designated respectively with the numbers 89¹ and 89², which are part of a set of the same ones that fill the toroidal gap created by the confrontation of the feeding rolling channel (6) and the channel of motor rolling one (17) I appeared do for the purpose of introducing the motor rotor (29) inside (01) the feeding case (01).

Two spheres, designated respectively with the numbers 89³ and 89⁴, which are part of a set of the same ones that fill the toroidal hole created by the confrontation of the evacuation rolling channel (06) and the channel of motor rolling two (17′) appeared for the purpose of inserting the motor rotor (29) inside (01) the evacuation case (00¹).

Due to the introduction of the motor rotor (29) inside the sinus (1) of feeding case (0¹), four toroidal holes appear, created by the confrontation of their respective joint channels; in each of them there is a joint, called and designated as follows:

The high feeding joint, designated on its lower slope with the number 814, which fills the channel of the high feed static joint (7) and the channel of the upper feed motor joint (18).

The medium-high feed joint, designated on its lower slope with the number 883, which fills the medium-high feed static joint channel (8) and the medium-high feed motor joint channel (19).

The low-middle feed joint, designated on its lower slope with the number 882, which fills the medium-high feed static joint channel (9) and the medium-low feed motor joint channel (20).

The middle high feed seal, designated on its lower slope with the number 881, which fills the low feed static seal channel (10) and the low feed driving seal channel (21).

For the purpose of introducing the motor rotor (29) inside (01) the evacuation casing (00), four toroidal holes appear, created by the confrontation of their respective joint channels; in each of them there is a board, called and designated as follows:

The high evacuation joint, designated on its lower side with the number 88′₄, which fills the toroidal gap created by the confrontation of the channel of the static joint of high evacuation (07) and the channel of the motor joint of upper evacuation (18′).

The medium-high evacuation joint, designated on its lower side with the number 88′₃, which fills the toroidal gap created by the confrontation of the channel of the static medium-high evacuation joint (08) and the channel of the upper motor joint (219′).

The lower middle evacuation joint, designated on its lower slope with the number 88′₂, which fills the toroidal gap created by the confrontation of the lower middle evacuation static joint channel (09) and the upper motor joint channel (20¹).

The low evacuation joint, designated on its lower side with the number 88′₁, which fills the toroidal gap created by the confrontation of the channel of the static joint of medium-high evacuation (10) and the channel of the upper motor joint (21).

The assembly is firmly and stably joined by three ties, of which only the upper one (15₅) can be seen, so that the feeding case (0) and the evacuation case (00¹) are crossed by it (15⁸). housing (0¹ and 00¹) a motor rotor (29) in their respective sinuses.

Motor rotor (29), is here occupied by a pinion, hidden for graphic clarity, which is crossed by the pedals (61₁ and 61₂) that are firmly installed there.

It can be seen how the assembly is also anchored by the anchor (15₅) to the vehicle (60) in a section thereof.

In addition, it has connected, keeping tightness with the outside in its union:

To its feeding duct (2), a sleeve section (31₁) with its channel (32₁).

To its evacuation conduit (02), a sleeve section (31₂) with its channel (32₂).

FIG. 44 represents the external profile of a motor device resulting from the combination of two complete motor devices; the assembly is firmly and stably joined by three anchors, of which only the upper one (15₅) can be seen, so that their respective feeding (0¹ and 0³) and evacuation (00¹ and 00³) cases are crossed by this (15₅) and house (0¹ and 00¹) and (0³ and 00³) aligned to two driving rotors (29₁ and 29₂).

It can be seen how the assembly is also anchored by the anchor (15₅) to the vehicle (60) in two sections thereof.

Thus, the evacuation casing (00¹) of the element located furthest to the left is glued to the feeding casing (03) of the one located on the right, aligning their respective casing tracks, which are not seen here, so the respective power intakes of the motor rotors (29₁ and 29₂) are also continuous, here occupied by their respective pinions, hidden for graphic clarity, which are crossed by the pedals (61₃ and 61₄) that are firmly installed there.

A light source (100) can also be seen, located in evacuation case counter (0101) of the evacuation case (00³), and a sensor (110), located in the feeding case counter (101) of the feeding case (0¹).

It also connect, keeping tightness with the outside at their union, its feeding duct (2) to a sleeve section (311) with its channel (321).

To its feeding conduit (2), a sleeve section (31₁) with its channel (32₁).

To its evacuation duct (02), a sleeve section (31₂) with its channel (32₂).

Both are a continuation of the sleeves seen in the previous figure with the same numbering.

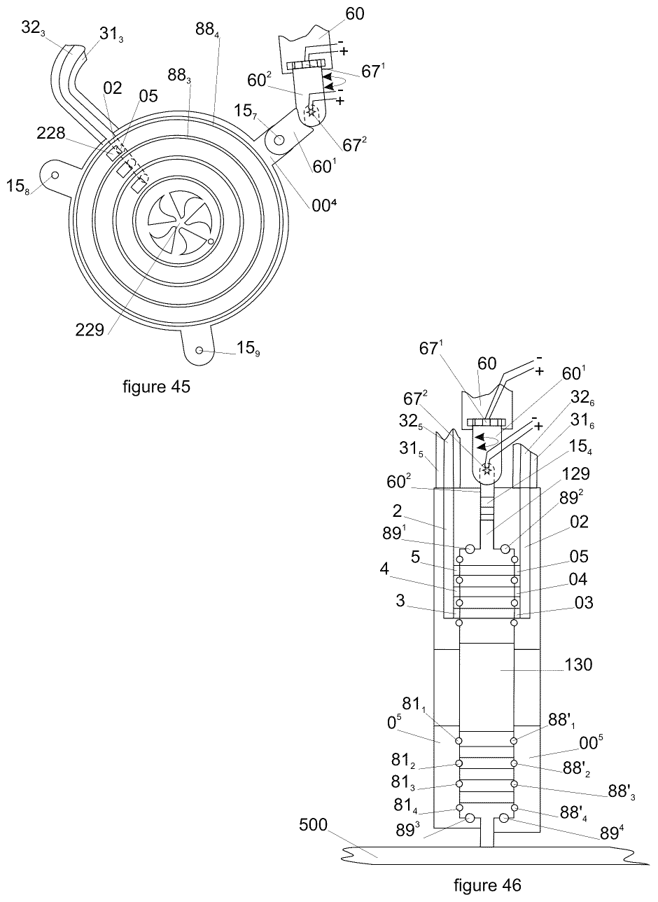

FIG. 45 corresponds to the external elevation of a complete propeller device, except for reasons of graphic clarity, its case and feeding duct.

The assembly formed by the supply casing and the evacuation casing, now the latter with the sign 00₄, is firmly and stably joined by three anchors, which the numbers 15₇, 15₈ and 15₉ respectively designate, so that both cases house a propeller rotor (229) capable of turning in their respective sinuses.

The upper right anchor (15₇) fixes the feeding and evacuation casing (00⁴) to the orientation device (60¹), while the link (60²) joins it (60¹) with the vehicle (60), so that the propeller device it can be oriented in any direction by the discretionary use by the pilot of the aircraft, ship or multipurpose vessel, depending on the case, of the director (67¹) and/or the elevator (67²).

The evacuation casing (00) is seen, which incorporates a propeller rotor (229) within it sinus (01) so that it (01) is hidden by it (229); In addition, its high outlet (05) and the evacuation conduit (02) are indicated, which has a sleeve section (31₃) connected to its outlet to the outside, keeping it tight with the surrounding environment, so that its channel (32₃) is an extension of that (02).

You can see the different joints with the same symbols used until now.

FIG. 46 is the view of a diametric section of a complete wheel device formed by:

A feeding case (0⁵) in which you can see:
it feeding duct (2).

Its low (3), medium (4) and high (5) solenoid valves.
a wheel rotor (129).

An evacuation case (00⁵) showing:
it evacuation duct (02).
its low (03), medium (04), and high (05) outputs.

Two spheres, designated respectively with the numbers 89² and 89⁴, which are part of a set of the same ones that fill the toroidal hole created by the confrontation of the evacuation rolling channel (06) and the channel rolling wheel two (117′) appeared when inserting the wheel rotor (129) inside the evacuation case (00⁵).

Due to the introduction of the wheel rotor (129) inside (1) the feeding case (0), four toroidal holes appear created by the confrontation of their respective joint channels; in each of them there is a board, called and designated as follows:

The high feed seal, designated on its lower side with the number 884, which fills the high feed static seal channel (7) and the upper feed wheel seal channel (118).

The medium-high feed joint, designated on its lower slope with the number 883, which fills the medium-high feed static joint channel (8) and the medium-high feed wheel joint channel (119).

The medium-low feed seal, designated on its lower slope with the number 882, which fills the medium-high feed static seal channel (9) and the medium-low feed wheel seal channel (120).

The middle high feed seal, designated on its lower slope with the number 881, which fills the low feed static seal channel (10) and the low feed wheel seal channel (121).

For the purpose of inserting the wheel rotor (129) inside (01) the evacuation casing (00), four toroidal holes appear, created by the confrontation of their respective joint channels; in each of them there is a board, called and designated as follows:

The high evacuation joint, designated on its lower side with the number 884′, which fills the toroidal gap created by the confrontation of the channel of the high evacuation static joint (07) and the channel of the upper evacuation wheel joint (118′).

The middle-high evacuation joint, designated on its lower side with the number 883′, which fills the toroidal gap created by the confrontation of the channel of the static joint of medium-high evacuation (08) and the channel of the upper wheel joint (119′).

The lower middle evacuation joint, designated on its lower side with the number 882′, which fills the toroidal gap created by the confrontation of the lower middle evacuation static joint channel (09) and the upper wheel joint channel (220′).

The low evacuation seal, designated on its lower side with the number 881′, which fills the toroidal hollow created by the confrontation of the channel of the static seal of medium-high evacuation (10) and the channel of the upper wheel seal (121).

The assembly is firmly and stably joined by three ties, of which only the upper one (154) can be seen, so that the supply casing (05) and the evacuation casing (005) pass through given by it (15₈) and house (05 and 005) a wheel rotor (229) and their respective sinuses (1 and 01).

It can be seen how the assembly is also anchored by the link (15₅) to the vehicle (60) in a section thereof, just as the other two links do.

In addition, it has connected, keeping tightness with the outside in its union:

To its supply duct (2), a sleeve section (315) with its channel (325).

To its evacuation conduit (02), a sleeve section (316) with its channel (326).

With the number 500 you can see the ground on which the wheel rotor (129) rests.

The upper anchorage, now designated as 154, fixes the vehicle (60) to the supply and evacuation casings, seen here with respective symbols 05 and 005, inserting the orienter (601) between them, while the link (602) joins them both (60 and 601) so that the wheel device can be oriented in any direction by discretionary use by the pilot of the aircraft, ship or multipurpose, depending on whether it is, the director (671) or the elevator (672).

Based on this, we will understand the electro-mechanical structure installed in a vehicle intended for the hydraulic transmission of energy through a round trip closed circuit, filled with oleo-hydraulic fluid ad nauseam, of a driving force applied to a rotary motor device, which is fixed in the vehicle in which it is installed, to a device for transferring said force, which provides the advancement of the vehicle (60) in question, whether it is a wheel device (129), if it is a land vehicle, or a propeller device (229), if it is air or sea, and both (129 and 229) if it is a multipurpose transport.

Both the wheel device (129) and the propeller (229) are also firmly rooted to the vehicle (60) they serve, but with the ability to pivot both (129 and 229) individually in three dimensions in their connection to it. (60) since, as has already been seen in FIGS. 42, 45 and 46, this joint is made up of respective electrical rotating ball joints, capable of giving them such orientation.

The driving device, which can be powered in its rotation by the energy applied thanks to the push of the legs of a cyclist on some pedals (61 and 61′) of a bicycle, which will require their proper location (61 and 61′) in the vehicle for effective pedalling, or by any type of motor adapted to said primary focus, so that the location of the motor element will depend on the transport in question.

Both the driving element and the wheel and propeller have basically the same physical structure, differing, as can be seen in the figures, in that while the driving element incorporates a pinion (16) to which some pedals (61) or a motor are circumstantially engaged, the The wheel incorporates a ring to its rotor (129) that allows it to rest and propel itself against the ground and, the propeller to its (229), some blades that are compressed behind them by the liquid or air fluid that surrounds them.

Being the same in this aspect, the location and ability to rotate properly of the motor rotors (29), wheel (129) and propeller (229) in their aforementioned location, are given by two series of spheres (891-893 and 89²-89⁴) which direct and separate them at a distance from their respective containers (0 and 00) that allows the sealing action of the two sets of joints located between the three elements as seen in FIGS. 43 and 46.

As can be seen in FIG. 13, the motor rotor (29) has the pinion (16) installed on its power take-off (30) in such a way that, when it rotates (16) in an anticlockwise direction, its teeth contact, without possibility of bending, against the vertices of the power take-off (30) and therefore the driving rotor (29) rotates at its thrust in its direction; on the other hand, as seen in FIG. 14, when the pedals are turned clockwise, the teeth (16) bend, sliding on the walls of the power take-off (30), so the drive rotor (29) remains static; the same happens, as shown in FIG. 15, if there is a faster rotation of the driving rotor (29) than that of the variable pinion (16), due to the slowing down or stopping of the pedaling with respect to the hydraulic traffic inside it (29), as occurs when the wheel rotor (129) rotates faster during the descent of a slope or the propeller rotor (229) of an aircraft in its descent in full flight.

Thus, each of said devices is made up of a container made up of two casings: one for supply and the other for evacuation (00); as we know, the first (0), has three solenoid valves behind its supply duct (2): the low (3), the medium (4) and the high (5), while the second (00), behind its duct evacuation (02) has low (03), medium (04) and high (05) outputs.

In each of the three cases, as both shells (0 and 00) are joined by the anchors (15) presenting the confrontation of their respective sinuses (1) and (01), by the insertion in the corresponding joint channels, static or mobile, of the joint (88) that fits into it, three supply spaces and three evacuation spaces are created: the upper, the middle and the lower.

In addition, the motor rotors (29), wheel (129) and propeller (229) inserted in each of the cases just mentioned between both casings (0 and 00) have three open turbines, respectively, with their blades located at different radius and obliquely to the bases of the disk that incorporates them; these are:

The largest motor turbine (22, 25 and 28 in FIGS. 4 and 5), which communicates the upper intake space with the upper evacuation space.

The middle motor turbine (24 and 27 in FIGS. 4 and 5), which communicates the middle supply space with the middle evacuation space.

The smaller motor turbine (23 and 26 in FIGS. 4 and 5), which connects the lower intake space with the lower evacuation space.

The largest turbine wheel (122, 125 and 128 in FIGS. 6 and 7), which communicates the upper intake space with the upper evacuation space.

The half-wheel turbine (124 and 127 in FIGS. 6 and 7), which communicates the middle supply space with the middle evacuation space.

The smallest wheel turbine (123 and 126 in FIGS. 6 and 7), which communicates with the low intake space and the low evacuation space.

The largest propeller turbine (222, 225 and 228 in FIGS. 8 and 9), which communicates the upper intake space with the upper evacuation space.

The half propeller turbine (224 and 227 in FIGS. 8 and 9), which communicates the middle supply space with the middle evacuation space.

The smaller propeller turbine (223 and 226 in FIGS. 8 and 9), which connects the lower intake space with the lower evacuation space.

As the driving device seen in FIG. 41 has its supply duct (2) connected, by means of the hose (31), to the evacuation duct (02) of the wheel device shown in FIG. 42, just as the first has its discharge duct. evacuation connected to the supply of the second, by means of a hose similar to that (31) located behind it (31) in said images, the closed hydraulic circuit indicated at the beginning is created, being the solenoid valves of both supply casings, the motor and the wheel, which are responsible for allowing the circulation of the flow through one or another of their respective turbines, so that the control (53), to which all the solenoid valves are connected, is in charge of opening only one of them in the driving device, whatever it may be among the three, and another unique one among its trio in the wheel device; discretionary choice by the driver from the manager (54), since the latter (54) is capable of governing the former (53).

From the foregoing, it can be deduced that there will be nine different combinations in opening and closing between the solenoid valves of the drive device and the wheel device, which offers the possibility of applying the same number of developments in the wheel reception of the power applied to the drive, since The three turbines of each device have a different particular diameter and, therefore, a different relative volume displaced by rotation of the rotor in each of said links.

The same thing happens when the links are, under the same structure, the driving device and the propeller.

As can be seen in FIG. 44, a multiple configuration can be established in the motor device, in such a way that as many motor devices are joined in parallel, their respective pinions sharing a single focus of rotation (613 and 614), such as wheel or propeller devices. want to be installed on the vehicle, maintaining the aforementioned developments and increasing, proportionally to the receivers of oleo-hydraulic fluid, its emission.

Variant, which manages to multiply the number of tractor wheels of a land vehicle, propellers in aircraft and ship or both in hybrid vehicles of the previous ones.

The system explained so far requires an electronic control system, shown in FIG. 40, which incorporates an electrical source that is an electrical battery (52), which initially provides such a source to a stationary vehicle; but, to said hydraulic circuit, an electric generator-motor (36) capable of producing electrical energy due to the powerful rotation of any one of its rotors (29, 129 or 229), since any of its turbines drive the oleo-hydraulic fluid in its rotation, communicating the electricity generated to the battery (52) for simultaneous, subsequent or reserve use.

In addition, the motor-generator (36), due to its ability to inject the oleo-hydraulic fluid that circumstantially passes through it, as will be seen below, is suitable, as it is supplied with electric current from it (52), to supply the battery (52) and propel the vehicle in aid or substitution of the already mentioned rotating primary source of the driving element.

Since the gene The inductor-motor (36) has, as seen in FIG. 40, an inductor (42) capable of rotating near an armature (41) that surrounds it, creating a variation in the magnetic field exerted by the first (42) on the second (41) and, once this one (42) is contained in the first one (36), the turning cavity (40) is isolated with a cover (43), conferring to it (43) sealing with the outside, thanks to the connection of its energetic (39) and free (38) passages with the hydraulic circuit presented here by means of two hose sections (31 and 031), the oil-hydraulic flow can be directed in its traffic by these (39 and 38) by means of the electrical calibration of the respective flow given to one (38) by the regulator (50) and to another (39) by the regulator (50′) that are respectively their own.

Said optional discrimination by the driver of the vehicle is carried out electronically from the manager (54) through the control (53), and allows sending:

All the flow through the energetic passage (39), with which the maximum generative force is obtained, with a high plus of resistance on the motor action.

The discretionary distribution of flows between the energetic (39) and free (38) passages, with which more or less electric current is obtained, with its consequent increase in resistance, as already indicated.

All the flow through the free passage (38), with which no generative force is obtained, with the total absence of said resistance on the motor action.

The hydraulic circulation seen up to now occurs in only one direction; moreover, the hydraulic system presented here, has an electronic traffic inverter (69) inserted in its round-trip hoses (31) between the driving rotor and the wheel or propeller rotor in question in the assembly in question, the following operating system:

When its upper (76) and lower (77) valves are open and the reversing valves a (78) and reversing b (79) are closed, as seen in FIG. 24, the traffic on the circuit is that seen up to now and, by rolling the pedal (61) in the driving direction, the wheel or propeller in question rotates forward.

When its upper (76) and lower (77) valves are closed and the reversing valves a (78) and reversing b (79) are open, as seen in FIG. 25, the traffic in the circuit is inverted and, when the pedal (61) in the driving direction, the wheel or propeller in question rotates backwards.

The inclusion of the heater thermostat (37) in the generator-motor (36) gives the system the ability to know the temperature of the oleo-hydraulic fluid it contains and the discretionary option through the manager (54) of, at the command of the control (53), heating it by electrical supply from the battery (52) until reaching the most optimal degree of fluidity.

In the event that the system has the generator/motor (36) inserted in the flow or return duct that connects the wheel or propeller device with the inverter (69), the closing of its upper (76), lower (77) valves) and inverter a (78) and opening of inverter b (79), as seen in FIG. 26, assumes that traffic on the circuit is limited to the generator/motor (36) and the wheel or propeller device, leaving the driving device out of the circuit. This occurs automatically by the control (53) in the event that the electronic level (111), which is explained below, detects a situation of lowering the vehicle, usable for the transformation of potential energy into electricity by the generator/engine (36).

Electronic level (111) which, as seen in FIG. 37, is based on the existence of a dielectric liquid that fills two chambers up to half, respectively, creating in each of them:

A lower part (1131 and 1132) electro-conductive, dense and fluid.

A superior one (1121 and 1122) dry, gaseous and electro-insulating.

In said figure, the vehicle to which the level (111) is installed is horizontal and, consequently, the surface of both electro-conductive volumes (1131 and 1132) remains stable in landscape condition; This implies that the internal ends of the two electrical conductors (−1 and −2) housed in the lower parts (1131 and 1132) are bathed in dielectric, while the two electrical conductors (+1 and +2) housed in the chambers (1121 and 1122), being surrounded by said gas, are electrically isolated from those (−1 and −2), so there is no electrical circulation between the electrodes (−1 and +1) and (−2 and +2) and no signal reaches the control (53) so the control (53) does not process any action on the electrical system.

The ascent of a slope of a land vehicle or the ascent in height of an aircraft that carry the level described here implies, as shown in FIG. 38, that the vehicle to which the level (111) is installed is no longer horizontal, so the surface of both electro-conductive volumes (1131 and 1132) lose their horizontal condition; on the left side of the ni vel (111), the electro-conductive volume (1131) adopts the shape of a wedge, with its minor vertex to the left;

This implies that the two internal ends of the electrical conductors (+1 and −1) housed there remain electro-isolated, without emitting any signal to the control (53); meanwhile, to the right of it (111), the two electrical conductors (+2 and −2) are bathed by the dielectric (1132), so if there is electrical circulation between them (+2 and −2) giving a signal of such ascent to the control (53) so that the latter (53), upon receiving an optional order from the driver of the vehicle through the manager (54), processes the command on the electrical system to activate the generator/motor with electrical energy from the battery (52) in support of the effort made by the propulsive source of the vehicle in question.

Assistance that can be total, with the absolute closure of the free passage regulator (50′) and the maximum opening of the energetic passage regulator (50′), which gives the vehicle full electric power, or partial due to the game voluntary in the gradual opening and closing of both regulators (50′) and (50′).

The descent of a slope of a land vehicle or the descent in height of an aircraft carrying the level described here implies, as shown in FIG. 39, that the vehicle to which the level (111) is installed is no longer horizontal, so the surface of both electro-conductive volumes (1131 and 1132) lose their horizontal condition; in the right part of the level (111), the electro-conductive volume (1131) adopts the shape of a wedge, with its minor vertex to the right;

This implies that the two internal ends of the electrical conductors (+2 and −2) housed there remain electro-isolated, without emitting any signal to the control (53); meanwhile, to the left of it (111), the two electrical conductors (+1 and −1) are bathed by the dielectric (1131), so if there is electrical circulation between them (+1 and −1) giving signal of such descent to the control (53) so that the latter (53), upon receiving an optional order from the driver of the vehicle through the manager (54), processes on the electrical system the command to activate the generator/motor in energy producing mode to the battery (52) in order to take advantage of this decrease in the potential energy of the vehicle, storing it for later use.

Production, which can be total with the absolute closure of the free passage regulator (50′) and the maximum opening of the energetic passage regulator (50′), which gives the vehicle total or partial electric power due to voluntary play in the gradual opening and closing of both regulators (50′) and (50′); In addition, the inverter (69) is available at will to limit the oleo-hydraulic traffic to the wheel or propeller device, depending on the case, and to the generator/motor (36), avoiding friction and loss of power in the rest of the circuit.

The presence, on all devices, in their corresponding:

Power supply housing (0) of a spotlight (110).
Driving rotor (29), wheel (129) or propeller (229) of a counter (201).

Evacuation casing (00) of a photoelectric cell (100).

It causes that when the former (29, 129 or 229) rotates, due to its impulse to the pedals, motorized or due to the effect of a descent, in the sines (1 and 01) of both (0 and 00) it occurs in each revolution of the same (29), a light flash on the latter (100) coming from the first (110) through the motor meter (201), since the focus (110) is always connected to the battery (52).

Periodic succession that gives us, when their cadence is processed, the frequency and speed of rotation of each one of them, which is also processed in the control (53) and reflected in the manager (54) for any purpose.

It is not considered necessary to make this description more extensive so that any person skilled in the art understands the scope of the invention and the advantages derived from it.

The terms in which this report has been written must always be taken in a broad and non-limiting sense.

The materials, shape and arrangement of the elements will be subject to variation, as long as this does not imply an alteration of the essential characteristics of the invention presented here according to the following

[symbol]

1. Hydraulic transmission system with developments by electro-magnetic control for vehicles, with optional electric generation and propulsion comprising:
An electrical part, constituted by the connection by means of accommodating cables of:
An adjustable electric motor/generator (36), which has:
A free passage regulator (50).
An energetic step regulator (50′).
An induced stator (41).
A rotating inductor (42).
A battery (52).
An electronic control (53).
An electronic manager (54).
Two low feed solenoid valves (3).
Two medium feed solenoid valves (4 and 04).
Two high feed solenoid valves (5 and 05).
An upper valve (76).
A lower valve (77).
A reversing valve to (78).
A reversing valve b (79).
A directing motor (67¹).
A lift motor (67²).
A light bulb ((100).
A photoelectric sensor (110).
An electronic level (111).
A hydraulic part, which comprises four categories of rotating devices: two of them are energy sources: the driving device and the generator/motor; the first is in charge of providing the rest of the circuit of the hydraulic pressure produced by the 30 primary source of rotating energy, whether it is of human origin or an engine of any nature, while the second is circumstantially well of the facultative conversion into electricity already of said pressure injected by the rotor of the potential energy of the system during the descent of the vehicle, or of using the electrical energy accumulated in a battery to carry out said increase in pressure to the rest of the hydraulic circuit in aid or discretionary substitution of the aforementioned propulsive action applied to the device motor.
The remaining torque: a wheel device and a propeller device, are the respective ones in charge of releasing the force of the pressure supplied by both mentioned injector devices, either to the supporting medium in the case of a land vehicle, or to the envelope in that of a marine or air ship; application, the effect of which is the advancement of the vehicle, whatever its nature.
Consequently, the hydraulic circuit has:
One or more motive devices therefore, given the possibility that the system has one multiple reception devices for the oil-hydraulic fluid emitted by it or them; their number depends on the quantity of these receptors in order to provide adequate supply of said fluid.
One or more wheel character devices, according to the desired availability in the number of driving wheels of the vehicle in question.
One or more propeller devices, according to the desired availability in the number of thrust propellers of the vehicle in question.
One or more wheel and propeller devices, depending on the desired versatility in various travel spaces and the availability of traction in both of the vehicle in question.
The composition of the drive, wheel and propeller devices is basically the same since all three are made up of two container bodies that are:
A power supply casing (0), which has installed:
An evacuation casing (00).
The sufficient number of spheres to complete two series (89¹-89³ and 89²-89⁴) of them, each one filling the toroidal gaps that appear from the respective confrontations in each of the motor, wheel and propeller devices present in the system. in a matter of:
Its bearing channel in feed and the bearing groove one.
Its bearing channel in evacuation and the bearing groove two.
The sufficient number of low power joints (88₁) to fill the toroidal joint gaps of such size appeared by the respective confrontations in each of the driving, wheel and propeller devices present in the system in question.
The sufficient number of lower middle feed gaskets (88₂) to fill the toroidal gasket gaps of such magnitude that appeared by the respective confrontations in each of the driving, wheel and propeller devices present in the system in question.
The sufficient number of medium-high feed gaskets (88₃) to fill the toroidal gasket gaps of such magnitude that appeared by the respective confrontations in each of the driving, wheel and propeller devices present in the system in question.
The sufficient number of high feed gaskets (88₄) to fill the toroidal gasket gaps of such size appeared by the respective confrontations in each of the driving, wheel and propeller devices present in the system in question.
The sufficient number of low evacuation gaskets (88′₁) to fill the toroidal gasket gaps of such size appeared by the respective confrontations in each of the driving, wheel and propeller devices present in the system in question.
The sufficient number of medium-low evacuation gaskets (88′₂) to fill the toroidal gasket gaps of such size that appear from the respective confrontations in each of the motor, wheel and propeller devices present in the system in question.
The sufficient number of medium-high evacuation gaskets (88′₃) to fill the toroidal gasket gaps of such size that appear from the respective confrontations in each of the motor, wheel and propeller devices present in the system in question.
The sufficient number of high evacuation joints (88′₄) to fill the toroidal joint gaps of such magnitude that appear from the respective confrontations in each of the driving, wheel and propeller devices present in the system in question.
The three differ in that, while the motor device also incorporates:
A driving rotor (29).
A pinion (16).
Three anchors (15₁, 15₂ and 15₃) per driving device; which join, in the correct sequence, in a fixed and stable way to each other and to the vehicle (60), to the power supply (0) and evacuation (00) casing or casings of the combined motor device that includes the system, in the event that one or more wheel and/or propeller devices are installed in connection with it, their number, as seen above, goes hand in hand.
Some pedals (60₁ and 60₂) or a motor.
The wheel device includes:
A rotor wheel (129).
Three anchors (15₇, 15₈ and 15₉), which join together, in a fixed and stable way, the feeding and evacuation casings of the device; the anchor (15₇) fixes both housings to:
A link (60²), which articulates with the elevator (67²) to.
An orient (60¹), linked to the vehicle (60) by the ring (59) and engaged to the director (67¹).
And the propeller device (229):
A propeller rotor (229).
Three anchors (15₇, 15₈ and 15₉), which join together, in a fixed and stable way, the feeding and evacuation casings of the device; the anchor (15₇) fixes both housings to:
A link (60²), which articulates with the elevator (67²) to
An orient (60¹), linked to the vehicle (60) by the ring (59) and engaged to the director (67¹).
Given the possibility that there are many wheel and propeller devices connected to their corresponding driving devices:
An electronic inverter (69) for each pair formed by a driving device and a wheel or propeller in hydraulic communication.
The hoses (31) required to connect all the power lines (2) of the wheel and propeller devices that are installed to the exhaust duct (02) of the motor device that corresponds to it and to the evacuation ducts (02) of the latter with the corresponding feed (2) in the wheel and propeller devices; in addition to including the number of hoses (31) required to insert the aforementioned hoses (31), in each supply connection (2) and evacuation (02), their corresponding inverter (69) as already mentioned.

2. Hydraulic transmission system with developments by electro-magnetic control for vehicles, with optional electric generation and propulsion that, according to the first claim, is characterized in that each hydraulic circuit, the result of the union of a driving device with a wheel or with one helix, by means of separate hoses connected to their respective supply and evacuation conduits, has nine different channels, isolated from each other; channels, which are a continuation of the respective supply ducts (2) and evacuation (02) of both devices that when counting, the first (2) with three solenoid valves (3, 4 and 5) and the second with three outputs (03, 04 and 05) facing each other (3 to 03, 4 to 04 and 5 to 05) making way for their respective minor, medium and major turbines.
The oleo-hydraulic traffic is produced by only one of them, being the same one chosen by the driver of the vehicle when giving said preference to the system through its mandate to the manager (54) who reverts it to control (53), which processes the order to open the chosen supply solenoid valves in the driving device and in the wheel or propeller, while the rest remain blocked from the circulation through them. This gives rise to combinations of turbines of the same or different radius, which implies different power developments in each election.
As a generator/motor (36) is inserted in one of said hydraulic circuits of the system, and it has a new fork in the oleo-hydraulic communication, the driver of the vehicle can also choose the preference of movement through the free passage (38) or the energetic step (39) by means of the instruction corresponding to the manager (54) that reverts it to the control (53), which processes the order of greater or lesser opening of the free passage regulators (50) and energetic step (fifty′). This results in the variation of the electrical power generated by the generator/motor (36) while also offering a change in resistance to pedaling or to the action of the installed motor, as the case in question.
Set of regulators (50) and (50′) that also affects oleo-hydraulic traffic in case the driver decides to activate, with energy from the battery (52) and by order given to the control (53) by means of the manager (54), the rotation of the inductor (42) so that it forces the circulation of the fluid that bathes it, an action that will be more or less vigorous depending on the electrical intensity applied to the question and the degree of opening of the former (50) and (50′).

3. Hydraulic transmission system with developments by electro-magnetic control for vehicles, with optional electric generation and propulsion that, according to the first claim, is characterized in that the system has a level (111) that determines the horizontality or inclination in the advance of the vehicle, so such information serves to control (53), at the request of the vehicle driver by means of a relevant instruction to the manager (54), of a signal to activate the generator/engine in generating function by closing the free passage (38) and opening of the energetic passage (39).

4. Hydraulic transmission system with developments by electro-magnetic control for vehicles, with optional electric generation and propulsion which, according to the first claim, is characterized in that the wheel and propeller devices are steerable in three-dimensional space as they are connected to the vehicle by means of of two rotating ball joints, which have their feeding and evacuation housings (0) and (00) joined by an anchor (157) to a link (60²), which articulates with the elevator (67²) a guide (60¹), linked to the vehicle (60) by the ring (59) and engaged to the director (67¹).
The orientation of the wheel or propeller device in question is produced, at the request of the vehicle driver, by means of a relevant instruction to the manager (54), who demands from the control (53) the signal to activate the lift (67²) or the director (67¹) to the desired degree to orient the desired device in one direction or another.

5. Hydraulic transmission system with developments by electro-magnetic control for vehicles, with optional electric generation and propulsion that, according to the first claim, is characterized in that it can reverse the direction of oleo-hydraulic traffic while maintaining the direction of pedaling or rotation of the motor, For this, the cyclist, pilot or driver, acts at his discretion on the manager (54) and consequently the control opens or closes the upper (76), lower (77), inverter a (78) and inverter b (79) valves) to direct said flow through its upper right (70), upper left (71), lower right (72), left (73), pipe a (74) and pipe b channels so that the direction be one or the other as seen in the explanation.
